(19) United States
(12) Patent Application Publication
(10) Pub. No.: US 2015/0317979 A1
(43) Pub. Date: Nov. 5, 2015

(54) METHOD FOR DISPLAYING MESSAGE AND ELECTRONIC DEVICE

(71) Applicant: Samsung Electronics Co., Ltd., Gyeonggi-do (KR)

(72) Inventors: Chulhyung YANG, Gyeongsangbuk-do (KR); Jeongseob Kim, Daegu (KR); Yeunwook Lim, Daegu (KR)

(73) Assignee: Samsung Electronics Co., Ltd.

(21) Appl. No.: 14/692,120

(22) Filed: Apr. 21, 2015

(30) Foreign Application Priority Data
Apr. 30, 2014 (KR) 10-2014-0052898

(51) Int. Cl. G10L 17/22; G10L 13/02; G10L 15/26

(52) U.S. Cl. CPC G10L 17/22; G10L 15/26; G10L 13/02

(57) ABSTRACT

A method for displaying a message is provided. The method includes receiving a speech signal; converting, to a text representation, at least a part of the speech signal corresponding to a voice message object; and displaying, within the voice message object, a part of the text representation, corresponding to the at least the part of the speech signal, a first object selectable to fully view the text representation, and a second object selectable to play back the speech signal.

### PRIORITY

This application claims priority under 35 U.S.C. §119(a) to a Korean Patent Application filed on Apr. 30, 2014 in the Korean Intellectual Property Office and assigned Serial No. 10-2014-0052898, the entire content of which is incorporated herein by reference.

### BACKGROUND OF THE DISCLOSURE

1. Field of the Disclosure

The present disclosure relates generally to a method and apparatus for displaying a message, and more particularly, to a method for displaying a message corresponding to a speech signal and an electronic device therefor.

2. Description of the Prior Art

A chat-based messenger may provide a user with an environment for sending various types of messages such as text, images, moving images, and voice messages. Among chat-based messengers, a messenger for exchanging Push-To-Talk (PTT) messages provides an environment in which voice recording is activated while a touch of the PTT function button is recognized. If a release of the PTT function button is recognized, the recording ends, and then the recorded voice is sent to a messaging counterpart.

However, a messenger for exchanging PTT messages primarily uses only an icon for voice playback to display a message. When the contents of a voice message are large, or there is a large number of PTT messages to be displayed, (e.g., when there is a plurality of chat participants), users of the chat-based messenger cannot intuitively recognize PTT messages received from a plurality of users in a chat window.

### SUMMARY OF THE DISCLOSURE

The present disclosure has been made to address the above-mentioned problems and disadvantages, and to provide at least the advantages described below. Accordingly, an aspect of the present disclosure provides a method for displaying a message and an electronic device therefor, which can provide intuitive user experiences by displaying a PTT message along with additional information produced through a speech-to-text conversion function when the PTT message is displayed in a chat-based messenger.

According to an aspect of the present disclosure, a method for displaying a message is provided. The method includes receiving a speech signal; converting, to a text representation, at least a part of the speech signal corresponding to a voice message object; and displaying, within the voice message object, a part of the text representation, corresponding to the at least the part of the speech signal, a first object selectable to fully view the text representation, and a second object selectable to play back the speech signal.

According to another aspect of the present disclosure, an electronic device is provided. The electronic device includes a memory configured to store a speech signal received from at least one of: an audio module configured to receive the speech signal from a microphone, and a communication module configured to receive a voice message including the speech signal from an external electronic device; a speech-to-text conversion module configured to control conversion, to a text representation, of at least a part of the speech signal corresponding to a voice message object; and a display module for displaying, within the voice message object, a part of the text representation corresponding to the at least the part of the speech signal, a first object selectable to fully view the text representation, and a second object selectable to play back the stored speech signal.

According to another aspect of the present disclosure, a non-transitory computer-readable recording medium having recorded thereon a program for executing a method of displaying a message is provided. The method includes receiving a speech signal; converting, to a text representation, at least a part of the speech signal corresponding to a voice message object; and displaying, within the voice message object, a part of the text representation, corresponding to the at least the part of the speech signal, a first object selectable to fully view the text representation, and a object selectable to play back the speech signal within a voice message object.

### BRIEF DESCRIPTION OF THE DRAWINGS

The above and other aspects, features, and advantages of the present disclosure will be more apparent from the following detailed description in conjunction with the accompanying drawings, in which:

FIG. 1 is a block diagram illustrating a network environment including an electronic device according to an embodiment of the present disclosure;

FIG. 2 is a block diagram illustrating an electronic device according to an embodiment of the present disclosure;

FIG. 3 is a flowchart illustrating a method of displaying a voice message object in an electronic device according to an embodiment of the present disclosure;

FIG. 4 is a flowchart illustrating a method of outputting a message in an electronic device according to an embodiment of the present disclosure;

FIG. 5 illustrates a voice message object according to an embodiment of the present disclosure;

FIG. 6 illustrates a chat window including voice message objects according to an embodiment of the present disclosure;

FIG. 7 is a block diagram illustrating an electronic device according to an embodiment of the present disclosure; and

FIG. 8 illustrates communication protocols between electronic devices according to an embodiment of the present disclosure.

### DETAILED DESCRIPTION OF EMBODIMENTS OF THE PRESENT DISCLOSURE

Embodiments of the present disclosure are described below in detail with reference to the accompanying drawings. Various changes may be made to embodiments of the present disclosure described herein, and embodiments of the present disclosure may have various forms, such that certain embodiments are illustrated in the accompanying drawings and described below in detail. However, such embodiments of the present disclosure are not intended to limit the present disclosure, and it should be understood that embodiments of the present disclosure include all changes, equivalents, and substitutes within the spirit and scope of the present disclosure. Throughout the drawings, like reference numerals may be used to refer to like components.

It will be understood that the expressions “comprises” and “may comprise” are used to specify presence of a function, operation, component, etc., but do not preclude the presence of one or more functions, operations, components, etc. It will be further understood that the terms “comprises” and/or “has” when used in this specification, specify the presence of stated feature, number, step, operation, component, element, or a combination thereof but do not preclude the presence or addition of one or more other features, numbers, steps, operations, components, elements, or combinations thereof. In the present disclosure, the expression “and/or” includes each and any combination of enumerated items. For example, A and/or B is to be taken as specific disclosure of each of A, B, and A and B.

As used herein, terms such as “first,” “second,” etc. are used to describe various components, however, such components are not defined by these terms. For example, the terms such as “first,” “second,” etc. do not restrict the order and/or importance of the corresponding components. Such terms are merely used for distinguishing components from each other. For example, a first component may be referred to as a second component and likewise, a second component may also be referred to as a first component, without departing from the teaching of the inventive concept.

It will be understood that when an element or layer is referred to as being “on”, “connected to,” or “coupled to” another element or layer, the element or layer can be directly on, connected, or coupled to the other element or layer, and intervening elements or layers may be present. By contrast, when an element is referred to as being “directly on,” “directly connected to,” or “directly coupled to” another element or layer, there are no intervening elements or layers present.

The terminology used herein is for the purpose of describing particular embodiments only and is not intended to be limiting of the present disclosure. As used herein, the singular forms “a”, “an”, and “the” are intended to include the plural forms as well, unless the context clearly indicates otherwise.

Unless otherwise defined herein, all terms including technical or scientific terms used herein have the same definitions as commonly understood by those skilled in the art to which the present disclosure belongs. It will be further understood that terms, such as those defined in commonly used dictionaries, should be interpreted as having a definition that is consistent with their definition in the context of the specification and relevant art and should not be interpreted in an idealized or overly formal sense unless expressly so defined herein.

Examples of electronic devices according to embodiments of the preset disclosure may include smartphones, table Personal Computers (PCs), mobile phones, video phones, Electronic Book (e-book) readers, desktop PCs, laptop PCs, netbook computers, Personal Digital Assistants (PDAs), Portable Multimedia Players (PMPs), Motion Picture Experts Group (MPEG) Audio-Layer 3 (MP3) players, mobile medical appliances, cameras, wearable devices (e.g., Head-Mounted Devices (HMD), such as electronic glasses, electronic clothing, electronic bracelets, electronic necklaces, electronic appcessories, electronic tattoos, smartwatches, etc.

According to an embodiment of the present disclosure, the electronic device may be any of smart home appliances that have an operation support function. Examples of such smart electronic appliances include television, Digital Video Disk (DVD) players, audio players, refrigerators, air-conditioners, vacuum cleaners, electronic ovens, microwave ovens, laundry machines, air cleaners, set-top boxes, TeleVision (TV) boxes (e.g. Samsung HomeSync™, Apple TV™, and Google TV™), game consoles, electronic dictionaries, electronic keys, camcorders, and electronic frames, etc.

According to an embodiments of the present disclosure, examples of electronic devices may include a medical device (e.g. Magnetic Resonance Angiography (MRA), Magnetic Resonance Imaging (MRI), or Computed Tomography (CT)), Navigation devices, a Global Positioning System (GPS) receiver, an Event Data Recorder (EDR), a Flight Data Recorder (FDR), a car infotainment device, a maritime electronic device (e.g., a maritime navigation device and gyro compass), an aviation electronic device (avionics), a security device, a vehicle head unit, an industrial or home robot, an Automatic Teller's Machine (ATM) of a financial institution, a Point Of Sales (POS), etc.

According to an embodiment of the present disclosure, examples of electronics device may include furniture and a building/structure having a communication function, an electronic board, an electronic signature receiving device, a projector, and a metering device (e.g. water, electric, gas, and electric wave metering devices). According to an embodiment of the present disclosure, the electronic device includes any combination of the aforementioned devices. According to an embodiment of the present disclosure, the electronic device may be a flexible device. Electronic devices according to embodiments of the present disclosure are not limited to the aforementioned devices.

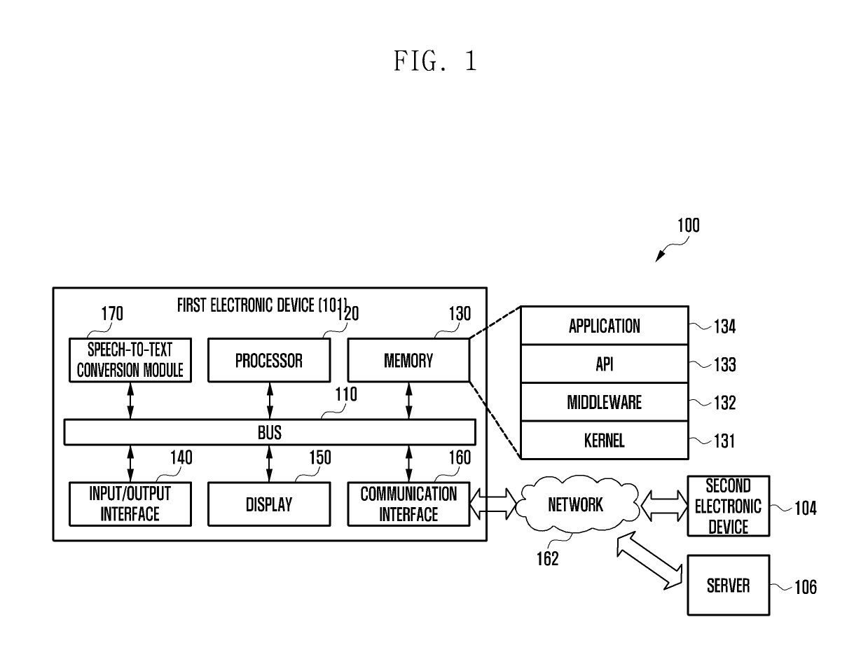

FIG. 1 is a diagram illustrating a network environment including an electronic device according to an embodiment of the present disclosure.

Referring to FIG. 1, a network environment 100 according to an embodiment of the present disclosure includes a first electronic device 101, a network 162, and external electronic devices including a second electronic device 104 and a server 106. The first electronic device 101 includes a bus 110, a processor 120, a memory 130, an input/output interface 140, a display 150, a communication interface 160, and a speech-to-text conversion module 170.

The bus 110 connects the aforementioned components to each other, and includes a circuit for exchanging signals (e.g. control messages) among the components.

For example, the processor 120 receives commands from any of the aforementioned components (e.g., memory 130, input/output interface 140, display 150, communication interface 160, and speech-to-text conversion module 170) through the bus 110, interprets the commands, and executes operation or data processing according to the decrypted commands.

The memory 130 stores the commands or data received from the processor 120 or other components (e.g., the input/output interface 140, the display 150, the communication interface 160, the speech-to-text conversion module 170, etc.) or generated by the processor 120 or other components. The memory 130 stores program modules a including kernel 131, a middleware 132, an Application Programming Interface (API) 133, applications 134, etc. Each programming module may be implemented as software, firmware, hardware, and any combination thereof.

The kernel 131 controls or manages the system resources (e.g. the bus 110, the processor 120, and the memory 130) for use in executing operations or functions implemented with the middleware 132, the API 133, or the application 134. The kernel 131 also provides an interface allowing the middleware 132, API 133, or application 134 to access the components of the first electronic device 101 to control or manage.

The middleware 132 works as a relay of data communicated between the API 133 or application 134 and the kernel 131. The middle 132 executes control of task requests from the applications 134 in a manner that assigns priority for use of the system resources (e.g., the bus 110, the processor 120, and the memory 130) of the electronic device 100 to at least one of the applications 134.

The API 133 is the interface provided for the applications 134 to control the functions provided by the kernel 131 or the middleware 132 and may include at least one interface or function (e.g. command) for file control, window control, image control, or text control.

According to various embodiments of the present disclosure, the applications 134 may include a Short Messaging Service/Multimedia Messaging Service (SMS/MMS) application, an email application, a calendar application, an alarm application, a health care application (e.g., an application of measuring quantity of motion or blood sugar level), and an environmental information application (e.g., atmospheric pressure, humidity, and temperature applications). In addition or as an alternative to the above-described applications, the application 134 may be an application related to information exchange between the first electronic device 101 and an external electronic device (e.g. the second electronic device 104). Examples of an information exchange application include a notification relay application for relaying specific information to the external electronic device and a device management application for managing the external electronic device.

For example, the notification relay application may be provided with a function of relaying alarm information generated by the other applications (e.g., the SMS/MMS application, the email application, the health care application, and the environmental information application) of the first electronic device 101 to the second electronic device 104. Additionally or alternatively, the notification relay application may provide the user with the notification information received from the second electronic device 104. The electronic device application manages (e.g., installs, deletes, and updates) the functions of an external electronic device (e.g. turn-on/off of at least a part of the second electronic device 104) or adjust the brightness or resolution of the display) that communicates with the first electronic device 101, or provides a service (e.g., communication or messaging service) provided by the external electronic device or an application running on the external device.

According to various embodiments of the present disclosure, the applications 134 may include an application designated according to the property (e.g., a type) of the second electronic device 104. If the external electronic device is an MP3 player, the applications 134 may include a music playback application. Similarly, if the external electronic device is a mobile medical appliance, the applications 134 may include a health care application. According to an embodiment of the present disclosure, the application 134 may include at least one application designated for the first electronic device 101 or received from an external electronic device (e.g., server 106 and the second electronic device 104).

The input/output interface 140 delivers commands or data input by the user through with an input/output device (e.g. a sensor, a keyboard, or a touchscreen) to the processor 120, memory 130, communication interface 160, and/or speech-to-text conversion module 170 through the bus 110. For example, the input/output interface 140 may provide the processor 120 with the data corresponding to a touch input made by the user on the touchscreen. The input/output interface 140 may output commands or data (e.g., received from the processor 120, memory 130, communication interfaced 160, or the speech-to-text conversion module 170 through the bus 110) through the input/output device (e.g. a speaker and/or a display). For example, the input/out interface 140 may output the voice data processed by the processor 120 to the user through the speaker.

The display 150 presents various information (e.g., multimedia data or text data) to the user.

The communication interface 160 may establish a communication connection between the first electronic device 101 and an external device (e.g. the second electronic device 104 and the server 106). For example, the communication interface 160 connects to the network 162 through a wireless or wired link for communication with the external device. Examples of the wireless communication technology include Wireless Fidelity (Wi-Fi), Bluetooth (BT), Near Field Communication (NFC), Global Positioning System (GPS), and cellular communication technology (e.g. Long Term Evolution (LTE), LTE-Advanced (LTE-A), Code Division Multiple Access (CDMA), Wideband CDMA (WCDMA), Universal Mobile Telecommunication System (UMTS), Wireless-Broadband (WiBro), and General System for Mobile communications (GSM). Examples of the wired communication technology include Universal Serial Bus (USB), High Definition Multimedia Interface (HDMI), Recommended Standard 232 (RS-232), and Plain Old Telephone Service (POTS).

According to an embodiment of the present disclosure, the network 162 may be a telecommunication network. The communication network may include computer network, Internet, Internet of Things, or telephone network. According to an embodiment of the present disclosure, the communication protocol between the first electronic device 101 and an external device (e.g., a transport layer protocol, a data link layer protocol, or a physical layer protocol) may be supported by the applications 134, API 133, middleware 132, kernel 131, or communication interface 160.

According to an embodiment of the present disclosure, the server 106 may execute operations (or functions) implemented at the first electronic device 101 to support the operation of the first electronic device 101. For example, the server 106 may include an item recommendation server module capable of supporting the speech-to-text conversion module 170 included in the first electronic device 101. For example, the item recommendation server module may include a part of the speech-to-text conversion module 170 to perform (e.g., instead of the speech-to-text conversion module 170) at least one of the operations managed by the speech-to-text conversion module 170.

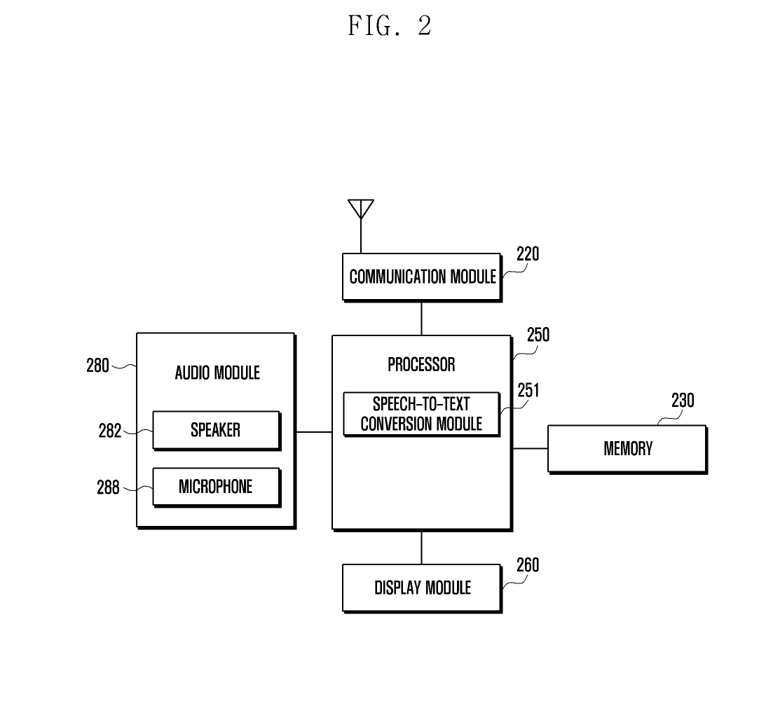

The speech-to-text conversion module 170 processes at least some pieces of information acquired from other elements (e.g., the processor 120, the memory 130, the input/output interface 140, and the communication interface 160), and provides the processed information to a user in various ways. For example, the speech-to-text conversion module 170 controls at least some functions of the first electronic device 101, by using or independently from the processor 120, such that the first electronic device 101 is linked to other electronic devices (e.g., the second electronic device 104 or the server 106). According to an embodiment of the present disclosure, at least one element of the speech-to-text conversion module 170 may be included in the server 106, and the server 106 may support at least one operation that is implemented in the speech-to-text conversion module 170. Additional details of the speech-to-text conversion module 170 are described herein with reference to FIGS. 2 through 6.

FIG. 2 illustrates an electronic device (e.g., the first electronic device 101) according to an embodiment of the present disclosure, which includes a speech-to-text conversion module.

Referring to FIG. 2, a processor 250 performs the same functions as the processor 120 of FIG. 1. The processor 250 includes a speech-to-text conversion module 251. The speech-to-text conversion module 251 performs the same functions as the speech-to-text conversion module 170 of FIG. 1. The speech-to-text conversion module 251 reprocesses and analyzes speech signals received from an audio module 280 and a communication module 220. The speech-to-text conversion module 251 converts a reprocessed and analyzed speech signal to a text representation and stores the speech signal and the converted text representation in a memory 230. In the process of converting a speech signal to a text representation, the speech-to-text conversion module 251 converts at least a part of the speech signal to the text representation. When a part the speech signal is converted, the speech-to-text conversion module 251 begins the conversion with a meaningful part of the speech signal (i.e., valid speech sounds). The speech-to-text conversion module 251 determines whether to convert at least a part of the speech signal in consideration of network operator configurations, user settings, a bandwidth, electronic device capabilities, and the like. The speech-to-text conversion module 251 may control a display module 260 to display a part of the converted text representation within a voice message object included in a chat window. Further, the speech-to-text conversion module 251 may control the display module 260 to display an object for full text view, which allows the text representation to be displayed in full, along with the partially displayed text representation within the voice message object. The speech-to-text conversion module 251 may recognize a user's selection of the object for full text view. The speech-to-text conversion module 251 may control the display module 260 to display the full contents of the converted text representation.

Further, the speech-to-text conversion module 251 may control the communication module 220 to transmit a voice message including a speech signal, which is received from a microphone 288, to the second electronic device 104.

An electronic device according to an embodiment of the present disclosure includes a speech-to-text conversion module for controlling a display module that displays a chat window in which voice message objects are included, the voice message objects including a speech signal which a voice message contains, a part of a text representation corresponding to the speech signal, and an object for full text view, which has a function of displaying the full text representation; a memory that stores speech signals received from an audio module and a communication module; the audio module that receives the speech signal contained in the voice message from a microphone or outputs the speech single to a speaker; and the communication module that receives or transmits the voice message containing the speech signal from or to an external electronic device, wherein the speech-to-text conversion module controls the respective modules to receive the speech signal, convert at least a part of the speech signal to the text representation, and display a part of the text representation, corresponding to the part of the speech signal, the object for full text view, and the object for playing back the speech signal.

According to an embodiment of the present disclosure, the chat window is a screen within which users proceed with a chat between each other. The chat window may include a voice message object. The voice message object may collectively refer to objects indicating voice messages of a plurality of users. The voice message object may have various shapes, for example, may be displayed in the shape of a balloon. Further, only the contents contained in the voice message object may be displayed without displaying the voice message object itself. The voice message object may include a text representation, an object for voice playback, or an object for full text view. The text representation is a text representation to which a speech signal received from a user is converted. At least a part of text representation may be displayed within the voice message object. The object for voice playback has a function of playing back a speech signal contained in a voice message. When a user's selection of the object for voice playback is recognized, the speech-to-text conversion module 251 controls the speaker 282 to output the speech signal. The object for full text view has a function of displaying the full text representation when only a part of the text representation is displayed within the voice message object. When a user's selection of the object for a full text view is recognized, the speech-to-text conversion module 251 may fully convert the speech signal, when only a part of the speech signal has been previously converted, to the full text representation and may control the display module 260 to display the converted full text representation. Further, when the speech signal is fully converted to the text representation, but only a part of the text representation is displayed, the speech-to-text conversion module 251 may control the display module 260 to fully display the converted text representation.

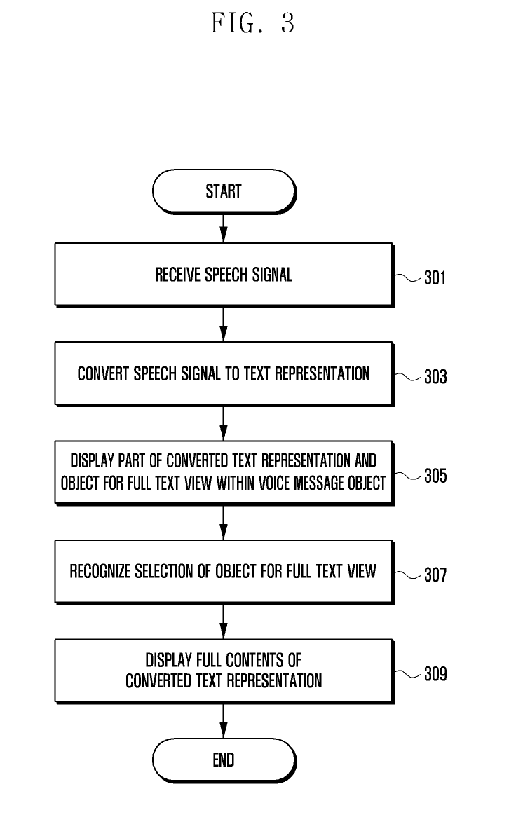

FIG. 3 illustrates a method of displaying a voice message object in an electronic device according to an embodiment of the present disclosure.

Referring to FIGS. 2 and 3, in operation 301, the speech-to-text conversion module 251 instructs the audio module 280 to receive sounds input in the form of a voice from a user by using the microphone 288, convert the input sounds to an electrical signal, and transfer the converted electrical signal to the speech-to-text conversion module 251. Further, when a voice message is received from the second electronic device 104, the speech-to-text conversion module 251 controls the communication module 220 to receive the speech signal of the voice message. In operation 302, the speech-to-text conversion module 251 reprocesses and analyzes the speech signal received from the audio module 280 or the communication module 220. The speech-to-text conversion module 251 converts the reprocessed and analyzed speech signal to a text representation and stores the speech signal and the converted text representation in a memory 230. In the process of converting the speech signal to the text representation, the speech-to-text conversion module 251 convert at least a part of the speech signal to the text representation. When only a part of the speech signal is converted, the speech-to-text conversion module 251 begins the conversion with a meaningful part of the speech signal (i.e., a part containing valid speech sounds). The speech-to-text conversion module 251 determines whether to convert at least a part of the speech signal in consideration of network operator configurations, user settings, bandwidth, electronic device capabilities, and the like. In operation 305, the speech-to-text conversion module 251 controls the display module 260 to display a part of the converted text representation within a voice message object included in a chat window. Further, the speech-to-text conversion module 251 controls the display module 260 to display an object for full text view, which allows the text representation to be displayed in full, along with the partially displayed text representation within the voice message object. In operation 307, the speech-to-text conversion module 251 recognizes a user's selection of the object for full text view. In operation 309, the speech-to-text conversion module 251 controls the display module 260 to display the full contents of the converted text representation.

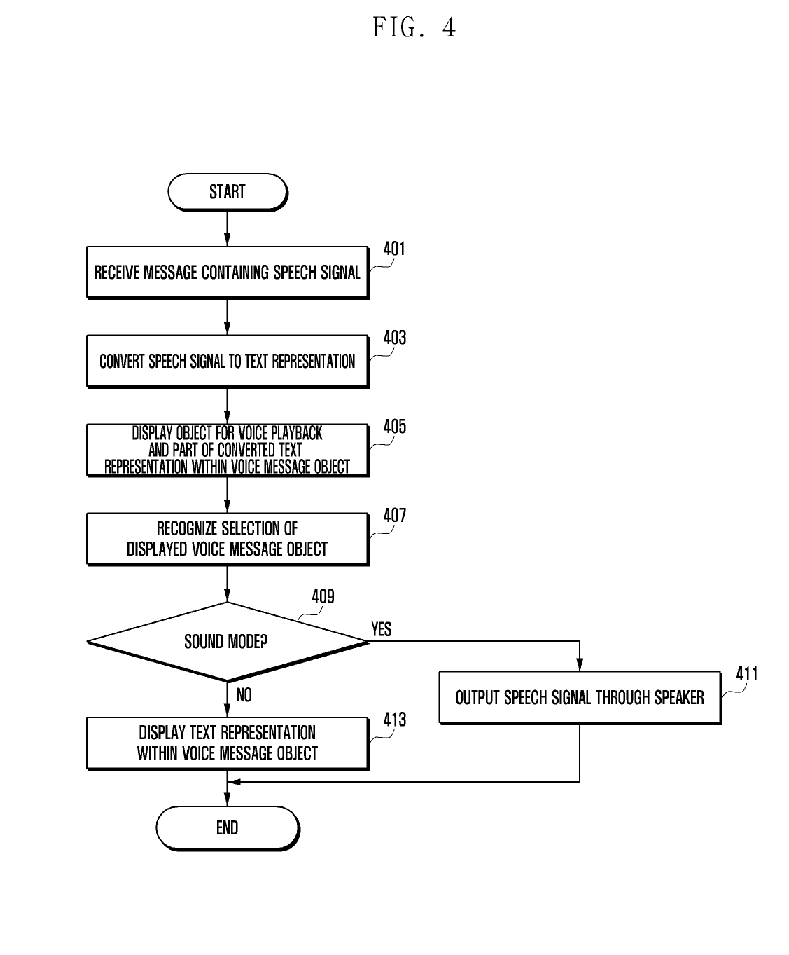

FIG. 4 illustrates a method of outputting a message in an electronic device according to an embodiment of the present disclosure.

Referring to FIGS. 2 and 4, in operation 401, the speech-to-text conversion module 251 may receive a voice message containing a speech signal from the second electronic device 104. The speech-to-text conversion module 251 may control the communication module 220 to receive the speech signal contained in the voice message. In operation 403, the speech-to-text conversion module 251 reprocesses and analyzes the speech signal. The speech-to-text conversion module 251 converts the reprocessed and analyzed speech signal to a text representation. In the process of converting the speech signal to the text representation, the speech-to-text conversion module 251 converts at least a part of the speech signal to the text representation. In operation 405, the speech-to-text conversion module 251 controls the display module 260 to display a voice message object in a chat window. The voice message object includes an object for voice playback and a part of the converted text representation. In operation 407, the speech-to-text conversion module 251 recognizes a user's selection of the object for voice playback. In operation 409, the speech-to-text conversion module 251 determines the status of the audio playback mode. If the audio playback mode is determined to be set to a sound mode, then the speech-to-text conversion module 251 controls, in operation 411, the speaker 282 of the audio module 280 to output the speech signal corresponding to the voice message. If the audio playback mode is determined to be set to the vibration mode or mute mode, then the speech-to-text conversion module 251 controls the display module 260 to display the full text representation within the voice message object. If the speech signal is converted in part to the text representation in operation 403, then the speech-to-text conversion module 251 performs a process of fully converting the speech signal to a full text representation and controls the display module 260 to display the full text representation within the voice message object.

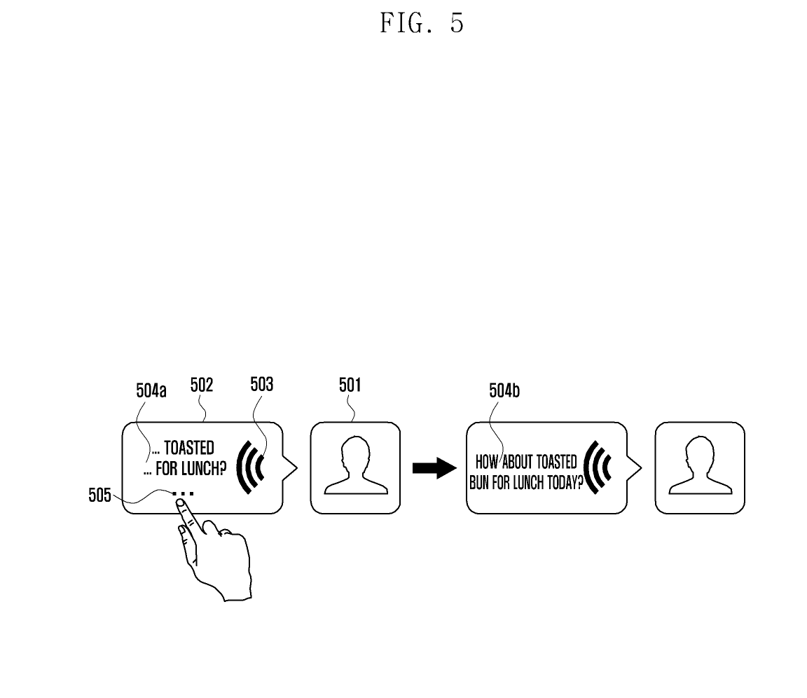

FIG. 5 illustrates a voice message object according to an embodiment of the present disclosure.

Referring to FIGS. 2 and 5, the speech-to-text conversion module 251 controls the display module 260 to display a voice message object 502 including a voice message, and a profile photo 501 identifying a user who is the sender of the voice message in order to display the voice message from the user. The voice message object 502 may collectively mean objects indicating voice messages of a plurality of users. The voice message object may have various shapes and, for example, may be displayed in the shape of a balloon. Further, only the contents contained in the voice message object are displayed while the voice message object itself is not displayed.

The voice message object 502 includes a text representation 504a, an object for voice playback 503, and an object for full text view 505. The text representation is a text representation to which the speech signal received from the user is converted. The speech-to-text conversion module 251 controls the display module 260 to display a part of the text representation 504a or the full text representation 504b within the voice message object 502. The object for voice playback 503 has a function of playing back the speech signal contained in the voice message. When a user's selection of the object for voice playback 503 is recognized, the speech-to-text conversion module 251 controls the speaker 282 to output the speech signal. The object for full text view 505 has a function of displaying the full text representation 504b when only a part 504a of the text representation is displayed within the voice message object 502. When a user's selection of the object for full text view 505 is recognized, the speech-to-text conversion module 251 fully converts the speech signal, only a part of which has been converted, to the full text representation and may control the display module 260 to display the converted full text representation 504b. Further, when the speech signal is fully converted to the text representation, but only a part 504a of the text representation is displayed, the speech-to-text conversion module 251 controls the display module 260 to fully display the converted text representation 504b.

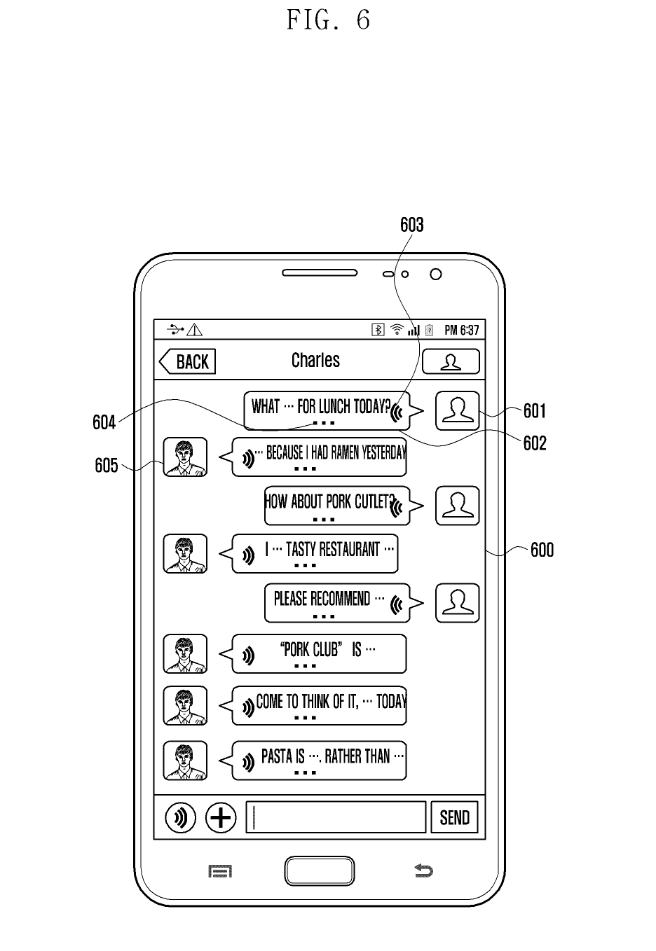

FIG. 6 illustrates a chat window including voice message objects according to an embodiment of the present disclosure.

Referring to FIGS. 2 and 6, a chat window 600 includes user profile photos 601, 605 identifying the senders of voice messages. In addition to the user profile photos 601, 605, the chat window 600 includes voice message objects 602. When a voice message received from the user of an external electronic device (e.g., the second electronic device 104) is displayed in the chat window 600, the speech-to-text conversion module 251 controls the display module 260 to display the user profile photo 605 identifying the user of the external second electronic device 104 and the voice message object 602 containing the voice message received from the user of the second electronic device 104. The speech-to-text conversion module 251 displays the user profile photo and the voice message object 602 adjacent to each other, thereby allowing users to intuitively recognize the contents of a voice message and the user who is the sender of the corresponding voice message. The speech-to-text conversion module 251 controls the display module 260 to display an object for voice playback 603 and an object for full text view 604, which allows a partially displayed text representation to be displayed in full, within the voice message object 602.

For example, the speech-to-text conversion module 251 may control the display module 260 to display messages of the user of the corresponding electronic device on the right side of the chat window 600. Further, the speech-to-text conversion module 251 may control the display module 260 to display messages of the user of the second electronic device 104 on the left side of the chat window 600. Although a one-to-one chat is illustrated in FIG. 6, this is merely provided an example, and embodiments of the present disclosure are not limited thereto. The speech-to-text conversion module 251 controls the microphone 288 of the audio module 280 to receive sounds in the form of a voice saying “What do you want for lunch today? How about ramen?”, and converts the received sounds to speech signals corresponding to an electrical signal. The speech-to-text conversion module 251 receives the speech signals from the audio module 280. The speech-to-text conversion module 251 reprocesses and analyzes the speech signal received from the audio module 280. The speech-to-text conversion module 251 may convert the reprocessed and analyzed speech signal to a text representation and stores the speech signal and the converted text representation in a memory 230. In the process of converting the speech signal to the text representation, the speech-to-text conversion module 251 converts at least a part of the speech signal to the text representation. The speech-to-text conversion module 251 displays a part of the converted text representation, “What . . . for lunch today?”, within the voice message object 602 in the chat window 600. Further, the speech-to-text conversion module 251 controls the display module 260 to display the object for full text view 604, which allows the text representation to be displayed in full, along with the partially displayed text representation within the voice message object 602. The speech-to-text conversion module 251 recognizes a user's selection of the object for full text view 604. The speech-to-text conversion module 251 controls the display module 260 to display the full contents of the converted text representation, “What do you want for lunch today? How about ramen?”. Further, the speech-to-text conversion module 251 receives sounds in the form of a voice saying “I don't feel like having ramen because I had ramen yesterday!” from the second electronic device 104, and converts the received sounds to an electrical signal. The speech-to-text conversion module 251 receives a speech signal corresponding to the converted electrical signal from the communication module 220. The speech-to-text conversion module 251 reprocesses and analyzes the speech signal received from the communication module 220. The speech-to-text conversion module 251 converts the reprocessed and analyzed speech signal to a text representation and stores the speech signal and the converted text representation in a memory 230. In the process of converting the speech signal to the text representation, the speech-to-text conversion module 251 converts at least a part of the speech signal to the text representation. The speech-to-text conversion module 251 displays a part of the converted text representation, “ . . . because I had ramen yesterday!”, within the voice message object 602 in the chat window 600. Further, the speech-to-text conversion module 251 displays the object for full text view 604, which allows the text representation to be displayed in full, along with the partially displayed text representation within the voice message object 602. When speech-to-text conversion module 251 recognizes a user's selection of the object for full text view 604, the speech-to-text conversion module 251 controls the display module 260 to display the full contents of the converted text representation, “I don't feel like having ramen because I had ramen yesterday!”.

A method according to an embodiment of the present disclosure includes receiving a speech signal; converting at least a part of the speech signal to a text representation; and displaying a part of the text representation corresponding to the part of the speech signal, an object for fully viewing the text representation, and an object for playing back the speech signal within a voice message object.

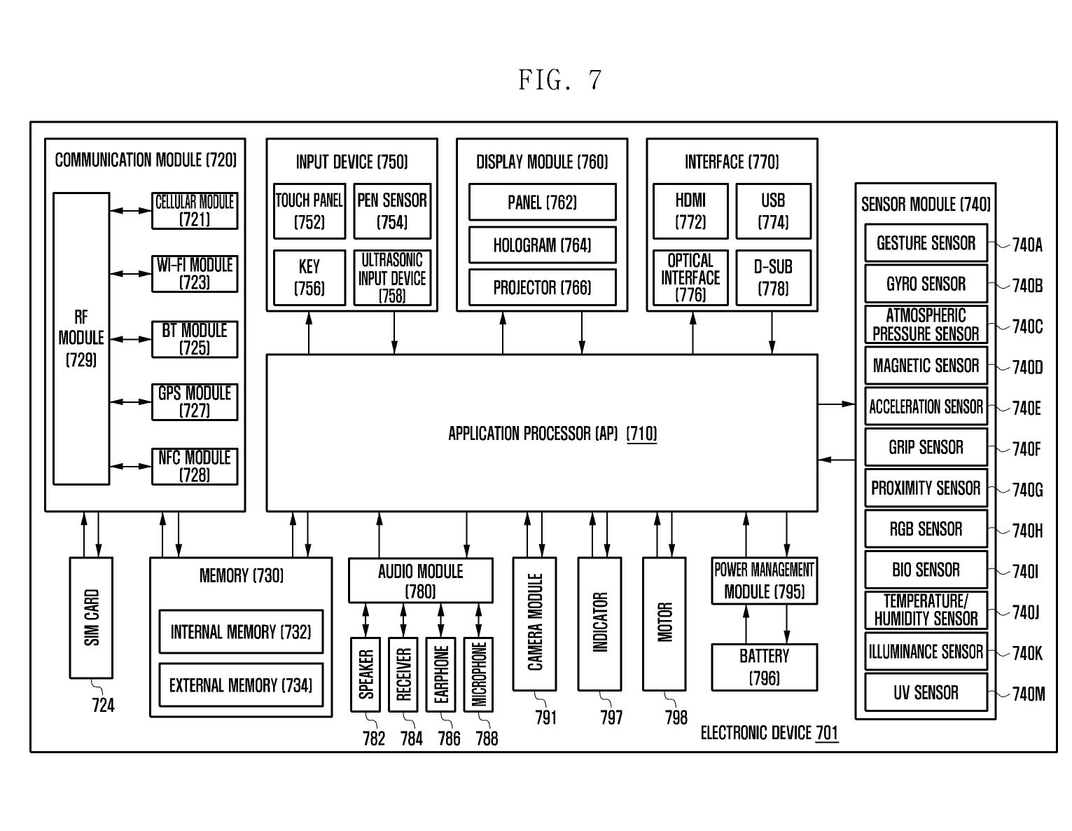

FIG. 7 is a block diagram illustrating a configuration of the electronic device according to an embodiment of the present disclosure.

Referring to FIG. 7, an electronic device 701 may be a least a part of the first electronic device 101. The electronic device 701 includes an Application Processor (AP) 710, a communication module 720, a Subscriber Identity Module (SIM) card 724, a memory 730, a sensor module 740, an input device 750, a display 760, an interface 770, an audio module 780, a camera module 791, a power management module 795, a battery 796, an indicator 797, and a motor 798.

The AP 710 operates an Operating System (OS) and/or application programs to control a plurality of hardware and/or software components connected to the AP 710 and performs data-processing and operations on multimedia data. For example, the AP 710 may be implemented in the form of a System on Chip (SoC). According to an embodiment of the present disclosure, the AP 710 may include a Graphic Processing Unit (GPU).

The communication module 720 (e.g., the communication interface 160) performs data communication with other electronic devices (e.g. second electronic device 104 and server 106) through a network. According to an embodiment of the present disclosure, the communication module 720 includes a cellular module 721, a Wi-Fi module 723, a BT module 725, a GPS module 727, an NFC module 728, and a Radio Frequency (RF) module 729.

The cellular module 721 is responsible for voice and video communication, text messaging, and Internet access services through a communication network (e.g., LTE, LTE-A, CDMA, WCDMA, UMTS, WiBro, or GSM networks). The cellular module 721 performs identification and authentication of electronic devices in the communication network using the SIM card 724. According to an embodiment of the present disclosure, the cellular module 721 performs at least one of the functions of the AP 710. For example, the cellular module 721 may perform at least a part of the multimedia control function.

According to an embodiment of the present disclosure, the cellular module 721 may include a Communication Processor (CP). The cellular module 721 may be implemented in the form of an SoC. Although the cellular module 721 (e.g., a communication processor), the memory 730, and the power management module 795 are depicted as independent components separated from the AP 710, embodiments of the present disclosure are not limited thereto, but may be embodied in a way, such that the AP includes at least one of the other components (e.g., the cellular module 721) of the electronic device 701.

According to an embodiment of the present disclosure, each of the AP 710 and the cellular module 721 (e.g., a communication processor) loads a command or data received from at least one of the components on a non-volatile or volatile memory and process the command or data. The AP 710 or the cellular module 721 stores the data received from other components or generated by at least one of the other components of the electronic device 701 in the non-volatile memory.

Each of the Wi-Fi module 723, the BT module 725, the GPS module 727, and the NFC module 728 may include a processor for processing the data transmitted/received by the module. Although the cellular module 721, the Wi-Fi module 723, the BT module 725, the GPS module 727, and the NFC module 728 are depicted as independent blocks some of these modules (e.g., a communication processor corresponding to the cellular module 721 and a Wi-Fi processor corresponding to the Wi-Fi module 723) may be integrated in the form of SoC.

The RF module 729 is responsible for data communication (e.g., transmitting/receiving RF signals). Although not depicted, the RF module 729 may include a transceiver, a Power Amp Module (PAM), a frequency filter, and a Low Noise Amplifier (LNA). The RF module 729 also may include the elements for transmitting/receiving electric wave in free space (e.g., a conductor or a conductive wire). Although FIG. 7 is directed to an example in which the Wi-Fi module 723, the BT module 725, the GPS module 727, and the NFC module 728 are sharing the RF module 729, embodiments of the present disclosure are not limited thereto, but may be embodied in a way such that at least one of the Wi-Fi module 723, the BT module 725, the GPS module 727, and the NFC module 728 transmits/receives RF signals an independent RF module.

The SIM card 724 is designed to be inserted into a slot formed at a predetermined position of the electronic device. The SIM card 724 stores unique identity information (e.g., an Integrated Circuit Card Identifier (ICCID)) or subscriber information (e.g., an International Mobile Subscriber Identity (IMSI)).

The memory 730 (e.g., the memory 130) includes at least one of the internal memory 732 and an external memory 734. The internal memory 732 includes at least one of a volatile memory (e.g., Dynamic Random Access Memory (DRAM), Static RAM (SRAM), Synchronous Dynamic RAM (SDRAM) or a non-volatile memory (e.g., One Time Programmable Read Only Memory (OTPROM), Programmable ROM (PROM), Erasable and Programmable ROM (EPROM), Electrically Erasable and Programmable ROM (EEPROM), mask ROM, flash ROM, NAND flash memory, and NOR flash memory).

According to an embodiment of the present disclosure, the internal memory 732 may be a Solid State Drive (SSD). The external memory 734 may be a flash drive such as Compact Flash (CF), Secure Digital (SD), micro-SD, Mini-SD, eXtreme Digital (xD), and a Memory Stick. The external memory 734 may be connected to the electronic device 701 through various interfaces functionally. According to an embodiment of the present disclosure, the electronic device 701 includes a storage device (or storage medium) such as hard drive.

The sensor module 740 measures physical quantities or checks the operation status of the electronic device 701 and converts the measured or checked information to an electric signal. The sensor module 740 includes at least one of a gesture sensor 740A, a Gyro sensor 740B, barometric sensor 740C, a magnetic sensor 740D, an acceleration sensor 740E, a grip sensor 740F, a proximity sensor 740G, a color sensor 740H (e.g., a Red, Green, Blue (RGB) sensor), a bio sensor 740I, a temperature/humidity sensor 740J, an illuminance sensor 740K, and an Ultra Violet (UV) sensor 740M. Additionally or alternatively, the sensor module 740 may include an E-nose sensor, an ElectroMyoGraphy (EMG) sensor, an Electro EncephaloGram (EEG) sensor, an ElectroCardioGram (ECG) sensor, an InfraRed (IR) sensor, an iris sensor, and a fingerprint sensor. The sensor module 740 further includes a control circuit for controlling at least one of the sensors included therein.

The input device 750 includes a touch panel 752, a (digital) pen sensor 754, keys 756, and an ultrasonic input device 758. The touch panel 752 may be one of a capacitive, a resistive, an infrared, or a microwave type touch panel. The touch panel 752 includes a control circuit. When the touch panel 752 is a capacitive type touch panel, the touch panel 752 is used to detect physical contact or approximation. The touch panel 752 may further include a tactile layer. In this case, the touch panel 752 may provide the user with haptic reaction.

The (digital) pen sensor 754 may be implemented with a sheet in same or similar manner as used to receive touch input of the user, or may use a separate recognition sheet. The keys 756 may include any of physical buttons, optical key, and keypad. The ultrasonic input device 758 is a device capable of checking data by detecting sound wave through a microphone 788 and may be implemented for wireless recognition. According to an embodiment of the present disclosure, the electronic device 701 receives the user input made by means of an external device (e.g. computer or server) connected through the communication module 720.

The display 760 (e.g., display module 150) includes a panel 762, a hologram device 764, and a projector 766. The panel 762 may be, for example, a Liquid Crystal Display (LCD) panel or an Active Matrix Organic Light Emitting Diodes (AMOLED) panel. The panel 762 may be implemented so as to be flexible, transparent, and/or wearable. The panel 762 may be implemented as a module integrated with the touch panel 752. The hologram device 764 presents a 3-dimensional image in the air using an interference of light. The projector 766 projects an image onto a screen. The screen may be placed inside or outside of the electronic device 701. According to an embodiment of the present disclosure, the display 760 includes a control circuit for controlling the panel 762, the hologram device 764, and the projector 766.

The interface 770 includes a High-Definition Multimedia Interface (HDMI) 772, a Universal Serial Bus (USB) 774, an optical interface 776, and a DOsubminiature (D-sub) 778. The interface 770 may include the communication interface 160 as shown in FIG. 1. Additionally or alternatively, the interface 770 may include a Mobile High-definition Link (MHL) interface, a SD/MMC card interface, and an infrared Data Association (irDA) standard interface.

The audio module 780 convert sound to electric signals and vice versa. At least a part of the audio module 780 is included in the input/output interface 140 as shown in FIG. 1. The audio module 780 processes the audio information input or output through the speaker 782, the receiver 784, the earphone 786, and the microphone 788.

The camera module 791 is a device that takes still and motion pictures and, according to an embodiment of the present disclosure, the camera module 791 includes at least one image sensor (e.g., a front sensor and/or a rear sensor), a lens (not shown), and Image Signal Processor (ISP) (not shown), and a flash (e.g. an Light Emitting Diode (LED) or a xenon lamp) (not shown).

The power management module 795 manages the power of the electronic device 701. Although not shown, the power management module 795 may include a Power Management Integrated Circuit (PMIC), a charger Integrated Circuit (IC), a battery, and a battery gauge.

The PMIC may be integrated into an integrated circuit or SoC semiconductor. The charging may be classified into wireless charging and wired charge. The charger IC may charge the battery and protect the charger against overvoltage or overcurrent. According to an embodiment of the present disclosure, the charger IC includes at least one of wired charger and wireless charger ICs. Examples of wireless charging technology include resonance wireless charging and electromagnetic wave wireless charging. An extra circuit for wireless charging (not shown), such as a coil loop, a resonance circuit, or a diode is required in order to implement wireless charging in the electronic device 701.

The battery gauge measures residual power of the battery 796, charging voltage, current, and temperature. The battery 796 stores or generates power and supply the stored or generated power to the electronic device 701. The battery 796 may include a rechargeable battery or a solar battery.

The indicator 797 may display an operation status of at least a part of the electronic device 701, a booting status, a messaging status, and a charging status. The motor 798 converts an electronic signal to mechanical vibration. Although not shown, the electronic device 701 may include a processing unit (e.g., a GPU) for supporting mobile TV. The processing unit for supporting the mobile TV may be able to process media data abiding by broadcast standards, such as Digital Multimedia Broadcasting (DMB), Digital Video Broadcasting (DVB), and media flow.

As described above, an electronic device operating method and apparatus according to an embodiment of the present disclosure are capable of providing diverse screen displays that are adapted to various conditions, to implement an optimal environment for utilizing the electronic device, resulting in an improvement of user convenience. An electronic device operating method and apparatus according to an embodiment of the present disclosure advantageously facilitates navigation between folders by sorting folders on a hierarchical level.

The above enumerated components of electronic devices according to embodiments of the present disclosure may be implemented into one or more parts, and the names of the corresponding components may be changed depending on the kind of the electronic device. An electronic device according to an embodiment of the present disclosure may include at least one of the aforementioned components while omitting some components and/or adding some components. Components of an electronic device of according to an embodiment of the present disclosure may be selectively combined into an entity to perform functions of the individual components in a manner equivalent to that performed without the combination.

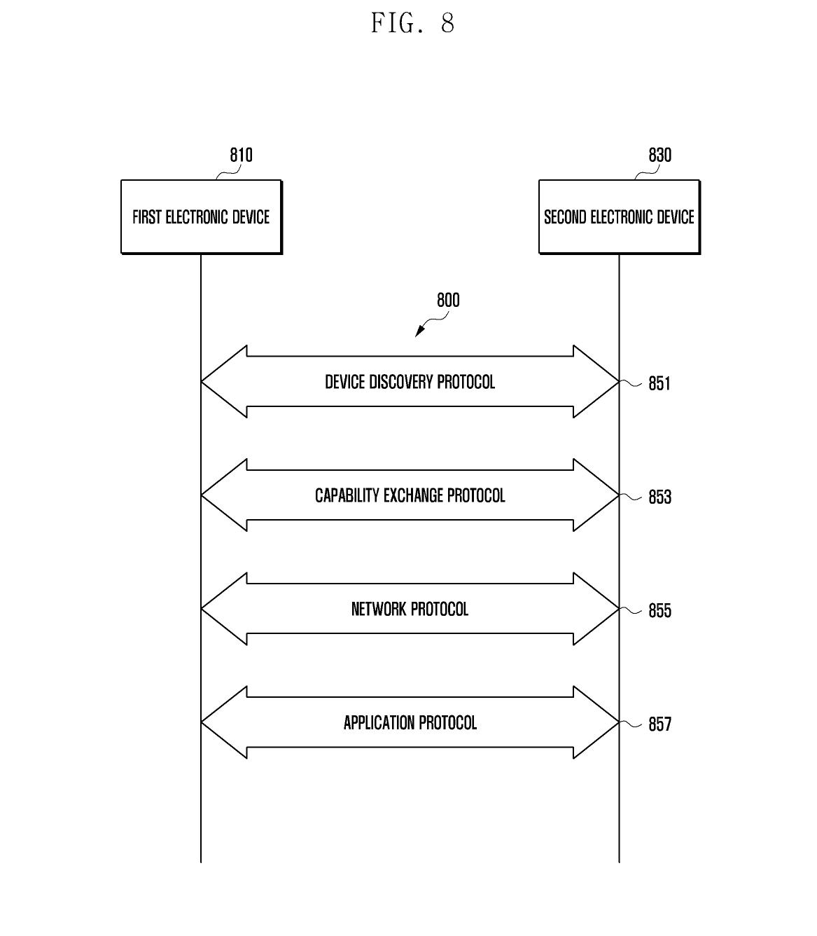

FIG. 8 illustrates communication protocols between electronic devices (e.g., an electronic device 810 and an electronic device 830) according to an embodiment of the present disclosure.

Referring to FIG. 8, for example, communication protocols 800 include a device discovery protocol 851, a capability exchange protocol 853, a network protocol 855, and an application protocol 857.

According to an embodiment of the present disclosure, the device discovery protocol 851 is a protocol by which the electronic devices (e.g., the first electronic device 810 and the second electronic device 830) detect external devices capable of communicating with the electronic devices, or connect with the detected external electronic devices. For example, the first electronic device 810 (e.g., the first electronic device 101) detects the second electronic device 830 (e.g., the second electronic device 104) as an electronic device capable of communicating with the first electronic device 810 through at least one communication method (e.g., WiFi, BT, USB, or the like) that is available in the first electronic device 810, by using the device discovery protocol 851. In order to connect with the second electronic device 830 for communication, the first electronic device 810 obtains and stores identification information regarding the detected second electronic device 830, by using the device discovery protocol 851. The first electronic device 810 initiates a communication connection with the second electronic device 830, for example, based on at least the identification information.

According to an embodiment of the present disclosure, the device discovery protocol 851 is a protocol for authentication between a plurality of electronic devices. For example, the first electronic device 810 performs authentication between the first electronic device 810 and the second electronic device 830, based on at least communication information {e.g., Media Access Control (MAC), Universally Unique Identifier (UUID), Subsystem Identification (SSID), Internet Protocol (IP) address} for connection with the second electronic device 830.

According to an embodiment of the present disclosure, the capability exchange protocol 853 is a protocol for exchanging information related to service functions that can be supported by at least one of the first electronic device 810 and the second electronic device 830. For example, the first electronic device 810 and the second electronic device 830 may exchange information on service functions that are currently supported by each of the first and second electronic devices 810 and 830 with each other through the capability exchange protocol 853. The exchangeable information includes identification information indicating a specific service among a plurality of services supported by the first electronic device 810 and the second electronic device 830. For example, the first electronic device 810 receives identification information for a specific service provided by the second electronic device 830 from the second electronic device 830 through the capability exchange protocol 853. In this case, the first electronic device 1010 determines whether the electronic device 810 can support the specific service, based on the received identification information.

According to an embodiment of the present disclosure, the network protocol 855 is a protocol for controlling the data flow that is transmitted and received between the first electronic device 810 and the second electronic device 830 connected with each other for communication, for example, in order to provide interworking services. For example, at least one of the electronic device 810 or the electronic device 830 may perform error control or data quality control, by using the network protocol 855. In addition to or alternative to being used for error control or data quality control, the network protocol 855 may determine the transmission format of data transmitted and received between the first electronic device 810 and the second electronic device 830. At least one of the electronic device 810 or the electronic device 830 manages a session (e.g., a session connection or a session termination) for the data exchange between the first electronic device 810 and the second electronic device 830, by using the network protocol 855.

According to an embodiment of the present disclosure, the application protocol 857 is a protocol for providing a procedure or information to exchange data related to services that are provided to external devices. For example, the first electronic device 810 may provide services to the second electronic device 830 through the application protocol 857.

According to an embodiment of the present disclosure, the communication protocol 800 includes standard communication protocols, communication protocols designated by individuals or groups (e.g., communication protocols designated by communication device manufacturers or network providers), or a combination thereof.

According to an embodiment of the present disclosure, storage media may store instructions that, when executed by at least one processor, causes the processor to perform at least one operation, and the at least one operation including receiving a speech signal; converting at least a part of the speech signal to a text representation; and displaying a part of the text representation, corresponding to the part of the speech signal, an object for fully viewing the text representation, and an object for playing back the speech signal within a voice message object.

The term “module” as used herein with respect to the embodiments of the present disclosure, refers to, but is not limited to, a unit of one of software, hardware, and firmware or any combination thereof. The term “module” may be used interchangeably with the terms “unit,” “logic,” “logical block,” “component,” or “circuit.” The term “module” may denote a smallest unit of component or a part thereof. The term “module” may be a smallest unit of performing at least one function or a part thereof. A module may be implemented mechanically or electronically. For example, a module may include at least one of Application-Specific Integrated Circuit (ASIC) chip, Field-Programmable Gate Arrays (FPGAs), and a Programmable-Logic Device that is already-known or to be developed for certain operations.

According to an embodiment of the present disclosure, the devices (e.g., modules or their functions) or methods may be implemented by computer program instructions stored in a computer-readable storage medium. When the instructions are executed by at least one processor (e.g., processor 120), the at least one processor executes the functions corresponding to the instructions. The computer-readable storage medium may be the memory 130. At least a part of the programming module may be implemented (e.g., executed) by the processor 120. At least a part of the programming module may include modules, programs, routines, sets of instructions, and processes for executing the at least one function.

The computer-readable storage medium includes magnetic media such as a floppy disk and a magnetic tape, optical media including a Compact Disc (CD) ROM and a Digital Video Disc (DVD) ROM, a magneto-optical media such as a floptical disk, and the hardware device designed for storing and executing program commands such as ROM, RAM, and flash memory. The programs commands include language code executable by computers using an interpreter as well as machine language codes created by a compiler. The aforementioned hardware device can be implemented with one or more software modules for executing the operations of embodiments of the present disclosure.

A module or programming module of the present disclosure may include at least one of the aforementioned components while omitting some components and/or adding other components. Operations of the modules, programming modules, or other components may be executed in series, in parallel, recursively, or heuristically in accordance with embodiments of the present disclosure. Some operations may be executed in a different order, omitted, or extended.

While the present disclosure has been shown and described with reference to certain embodiment thereof, it will be understood by those skilled in the art that various changes in form and details may be made therein without departing from the scope and spirit of the present disclosure as defined by the appended claims and their equivalents.

What is claimed is:

1. A method for displaying a message, the method comprising:
receiving a speech signal;
converting, to a text representation, at least a part of the speech signal corresponding to a voice message object; and
displaying, within the voice message object, a part of the text representation, corresponding to the at least the part of the speech signal, a first object selectable to fully view the text representation, and a second object selectable to play back the speech signal.

2. The method of claim 1, further comprising:
when a selection of the first object is recognized, converting all of the speech signal corresponding to the voice message object, to a second text representation; and
displaying the second text representation within the voice message object.

3. The method of claim 1, wherein receiving the speech signal comprises receiving the speech signal from at least one of an audio module and a communication module.

4. The method of claim 1, further comprising:
preprocessing the speech signal before converting the at least the part of the preprocessed speech signal to the text representation.

5. The method of claim 1, wherein converting the at least the part of the speech signal to the text representation comprises converting an amount of the speech signal to the text representation determined in consideration of at least one of network operator configurations, user settings, a bandwidth, and electronic device capabilities.

6. The method of claim 1, wherein converting the at least the part of the speech signal to the text representation comprises determining parts of the speech signal including valid speech sounds and converting the at least the part of speech signal to the text representation in an order from parts of the speech signal including validated speech sounds to parts of the speech signal that do not include validated speech sounds.

7. The method of claim 1, wherein displaying, within the voice message object, the part of the text representation, the first object, and the second object comprises:
determining a status of an audio playback mode when a selection of the voice message object is recognized; and
performing an operation based on the determined status.

8. The method of claim 7, wherein performing the operation based on the determined status comprises outputting the speech signal corresponding to the voice message object through a speaker when the audio playback mode is determined to be set to a sound mode.

9. The method of claim 7, wherein performing the operation based on the determined status comprises fully displaying the text representation corresponding to the voice message object within the voice message object when the audio playback mode is determined to be set to a vibration mode.

10. The method of claim 7, wherein performing the operation based on the determined status comprises fully displaying the text representation corresponding to the voice message object within the voice message object when the audio playback mode is determined to be set to a mute mode.

11. An electronic device comprising:
a memory configured to store a speech signal received from at least one of:
an audio module configured to receive the speech signal from a microphone, and
a communication module configured to receive a voice message including the speech signal from an external electronic device;
a speech-to-text conversion module configured to control conversion, to a text representation, of at least a part of the speech signal corresponding to a voice message object; and
a display module for displaying, within the voice message object, a part of the text representation corresponding to the at least the part of the speech signal, a first object selectable to fully view the text representation, and a second object selectable to play back the stored speech signal.

12. The electronic device of claim 11, wherein, when a selection of the first object is recognized, the speech-to-text conversion module further control conversion of all of the speech signal corresponding to the voice message object, to a second text representation, and to control the display module to display the second text representation within the voice message object.

13. The electronic device of claim 11, wherein the speech-to-text conversion module is further configured to control preprocessing of the speech signal before controlling conversion of the at least a part of the preprocessed speech signal to the text representation.

14. The electronic device of claim 11, wherein the speech-to-text conversion module is further configured to control conversion of an amount of the speech signal to the text representation determined in consideration of at least one of network operator configurations, user settings, a bandwidth, and electronic device capabilities.

15. The electronic device of claim 11, wherein the speech-to-text conversion module is further configured to control a determination of parts of the speech signal including valid speech sounds and to control conversion of the at least the part of the speech signal to the text representation in an order from parts of the speech signal including validated speech sounds to parts of the speech signal that do not include validated speech sounds.

16. The electronic device of claim 11, wherein the speech-to-text conversion module is further configured to control determination of a status of an audio playback mode when a selection of the voice message object is recognized, and to control performance of an operation based on the determined status.

17. The electronic device of claim 16, wherein the audio module is further configured to output the speech signal corresponding to the voice message object through a speaker when the audio playback mode is determined to be set to a sound mode.

18. The electronic device of claim 16, wherein the display module is further configured to display the text representation corresponding to the voice message object within the voice message object when the audio playback mode is determined to be set to a vibration mode.

19. The electronic device of claim 16, wherein the display module is further configured to display the text representation corresponding to the voice message object within the voice message object when the audio playback mode is determined to be set to a mute mode.

20. A non-transitory computer-readable recording medium having recorded thereon a program for executing a method of displaying a message, the method comprising:
receiving a speech signal;
converting, to a text representation, at least a part of the speech signal corresponding to a voice message object; and
displaying, within the voice message object, a part of the text representation, corresponding to the at least the part of the speech signal, a first object selectable to fully view the text representation, and a object selectable to play back the speech signal within a voice message object.
